(19) United States
(12) Patent Application Publication
(10) Pub. No.: US 2005/0173612 A1
(43) Pub. Date: Aug. 11, 2005

(54) Magnetic hole former

(76) Inventor: James V. Srackangast, Harrisburg, NC (US)

Correspondence Address: DOUGHERTY, CLEMENTS & HOFER, 1901 ROXBOROUGH ROAD, SUITE300, CHARLOTTE, NC, 28211, US

(21) Appl. No.: 10/772,559

(22) Filed: Feb. 5, 2004

(51) Int. Cl. B28B 7/16

(52) U.S. Cl. 249/142; 425/3

(57) ABSTRACT

An improved method and apparatus for attaching a hole former to a mold assembly for use in the formation of cast materials such as concrete and the like. The apparatus comprises a hole former assembly attached to a bracket. The bracket is held in a stationary position by a magnet assembly that is remotely located from the hole former. The magnet assembly is comprised of a plurality of magnets encased in a metal casing. An expendable blister pack can be provided to fit on the outside of the casing to facilitate removal of the magnetic assembly from the cast member.

### FIELD OF THE INVENTION

The present invention relates to cast members having holes formed therein. More particularly, the present invention relates to apparatuses and methods for accurately positioning and retaining a hole former or mandrel in a desired position during the casting process.

### BACKGROUND OF THE INVENTION

Hole formers, knock-out molds, and mandrels are well known in concrete casting, being utilized to accurately define and position an opening within a cast concrete structure, such as a manhole casting or drainage box. Pipes can then be mortared into the openings created by the hole formers and mandrels. Typical cast members are buried underground at depths reaching 30 feet. At these depths, accurate hole placement within the cast member becomes crucial in order to avoid costly retrenching and realignment of pipes with the cast member.

Traditionally, hole formers, mandrels and knock-out molds have been positioned in a concrete casting utilizing one of two methods. When casting the concrete, the hole former, mandrel or knock-out mold (collectively referred to as “hole formers” hereinafter) is placed so that the hole former's end cap is adjacent to at least one wall of the mold form. The first method calls for the hole former to then be attached to the mold form by drilling holes through the end cap of the hole former, into the mold form. A wire is then passed through the corresponding holes in order to attach the hole former to the inner mold and hold the hole former in place during the casting process.

However, different concrete forms often require holes in very different locations. This results in a myriad of holes that have to be drilled into the inner mold in order to accommodate and accurately place a hole in the concrete casting. This excessive drilling weakens the structural stability of the inner mold, which can result in chipped edges around unused holes. Additionally, the excess holes that are not being utilized to position a hole former become repositories for casting material, which makes removal of the casting from the inner mold more difficult. This can easily result in damaged and broken castings, thus increasing production time and costs.

Moreover, hole formers have a tendency to float in the casting medium. Wires that are used to attach the hole former to the inner mold often allow a shifting of the hole former, so that the final placement of the hole in the casting does not correspond with the precast placement. Holes in the casting therefore do not accurately align with the pipes to be attached.

The second method, of attachment involves utilizing a removable hanger that attaches to the top of the mold form. While this arrangement does not damage the mold form in ways similar to the use of bailing wire described above, it does suffer similar drawbacks in the shifting of the hole former during the casting process.

During the casting process, the mold form is often vibrated to remove air pockets from the cast material. This vibration often has the unfortunate effect of shifting the hole former from its desired location. While traditional hangers may retain the vertical alignment of the hole former during this vibration, horizontal or radial movement of the hole former is not as easily controlled.

Some manufacturers have tried to overcome the use of the hanging apparatus by securing the hole former in place with a centrally situated magnet. These devices also overcome problem of damaging the mold form, but are still subject to shifting of the hole former due to the combined buoyant and vibrational forces that are present during the casting process. This problem is compounded when the magnet is to be used with a manhole casting, where the mold form has a radial surface. The planar surface of the magnets centrally disposed in the hole former are not able to fully engage the radial surface of the manhole casting, resulting in a weakened attraction between the magnet and the mold form. Without experiencing the full force of the magnets, hole formers are much more easily displaced from their desired position during the casting process.

It would therefore be desirable to be able to accurately place and secure a hole former during the casting process that would not degrade the integrity of the mold form. Additionally, it would be beneficial to securely maintain the placement of the hole former during the casting process, overcoming any buoyant forces that may displace the hole former from its intended positioning. Finally, it would be beneficial to have a means of securing a hole former that would work equally well on both flat and radial surfaces.

### DESCRIPTION OF THE PRIOR ART

U.S. Pat. No. 3,686,815 issued to Von Bose discloses a method of building wall sections of a habitable structure utilizing two wall panels and a foamed core. Removable construction forms back up and support the wall panels during formation. The construction forms have a sheet of magnetizable material contacting the outer surface of the wall panels. Various fixtures, such as window and door frames, electrical outlets and the like can then be magnetically attached to the wall panels to be held in place for the remainder of the construction process. The space between the wall panels that is not occupied by the fixtures is then filled with a foamed in situ, synthetic, polymeric composition. The magnetic fixtures prevent the filling of the fixture voids. Once the foam solidifies, the wall panels are removed, leaving the completed wall section.

U.S. Pat. No. 3,786,386 issued to Cardone et al. concerns a magnetic device for use in printing systems whereby plates, cliches and the like are anchored to a ferro-magnetic support base. The invention also contemplates a specific magnet-positioning scheme, since apparently prior solutions that utilized this idea did not have the anchoring power to overcome the stresses acting on the plate during the printing process. Therefore, the plates would shift. The new magnet consists of a ferromagnetic support having slots. The slots are lined at the bottom with a non-magnetic metal such as aluminum, and then a permanent magnet battery is placed therein. This structure is then sealed with an epoxy resin. The permanent magnet battery can include a multiple magnet system.

U.S. Pat. No. 4,379,277 issued to Braillon teaches a magnetic chuck for the holding of a magnetically attractable work piece to a worktable or other support for a machine tool. The Braillon chuck creates a magnetic field on the lateral sides of the chuck, and not just the upper surface, as prior chucks have done. The chuck can be manually switched between an “on” state and an “off” state. In the “on” configuration, a series of alternating magnets in a first series on the chuck surface align with a second alternating series of magnets in a north-north/ south-south arrangement, so as to create a strong additive magnetic force on the surface of the chuck. When switched to the “off” configuration, the second magnet series slides so as to align itself with the first magnet series in a north-south/ north-south arrangement. This has the effect of canceling out the magnetic force that is experienced on the surface of the chuck so that the work piece can be easily maneuvered. The chuck contains a multiple magnet system so as to increase the attractive forces between it and the work piece.

U.S. Pat. No. 5,356,534 issued to Zimmerman discloses a magnetic-field amplifier that produces a composite magnetic field that may be used to treat fluids flowing in a conduit, or to provide an increased magnetic field to the armature of a motor, generator, or other magnetically operated device. The magnetic assembly is comprised of an inner magnetic structure containing 3 permanent magnets, a first and second ferromagnetic pole, a ferromagnetic cover, and a first and second non-magnetic insulating rod. A multiple magnet structure is used to increase the field strength applied to the conduit. Water flowing through the magnetic field causes a current to be generated that maintains the fluid flow in the conduit at a positive static charge. This positive charge helps to keep dissolved particles from precipitating out of solution and forming scale on the inside of the pipe.

U.S. Pat. No. 6,110,402 issued to Miller is directed to magnetically attachable hole forms which can be used in processes for casting manholes and related structures with holes or openings therein. The hole form is provided with a step through bore that is capable of receiving a magnet assembly which holds the hole form in place when it is placed on a wall surface of the casting mold. The face of the magnet should be contoured to match the surface of the wall form to which it is attached. The magnet assembly is provided with a threaded through-bore into which a bolt is placed in order to break the magnet assembly and the wall form.

U.S. Pat. No. 6,196,517 and its related divisional U.S. Pat. No. 6,371,436, both issued to Westhoff et al., describe a describes a two-piece ring placement assembly that is used in hole formation. The ring assembly is held to the core member of the mold assembly by a magnet that that can be mechanically released once the cast material has set. The magnet assembly is comprised of an interchangeable permanent magnet with a mounting plate that has a mechanical release mechanism thereon that functions similarly to the release mechanism described in the Miller '402 patent. The ring assembly is provided with knockout pads that ease the separation of the two pieces should they become adhered together in the casting process. The invention also discloses a one-piece hole former with a similar magnet assembly.

U.S. Pat. No. 6,454,686 issued to McEachem is directed to a magnetic cylinder or drum for use in holding printing plates, embossing plates, and the like. The cylinder is provided with offset recesses in to the cylinder for the receiving of magnet assemblies. The use of multiple magnets inserted into the various recesses is disclosed.

U.S. Pat. No. 6,575,424 issued to Domizio discloses void forming device for use with concrete casting molds. The device consists of a resilient member with a lifting member contained therein. The resilient member is anchored to the wall of the casting mold by way of a mounting structure. The patent discloses securing the mounting structure to the casting wall utilizing magnetic fasteners. The resilient member creates a recess into the cast material, such that the lifting member extends from the recess into the cast material. Once the cast material has hardened, the mounting structure and the resilient member are removed, leaving the lifting member embedded in the cast recess previously occupied by the resilient member.

U.S. Pat. Application publication No. U.S. 2003/0047664 discloses a sleeve holder cast into a wall type structure through which conduits and wires can be run. The apparatus is comprised of a flexible plastic material so as to permit the sleeve holder to conform to nonvertical and nonparallel sidewalls of the cast mold. A sleeve extends from one of such sleeve holders on the first wall of the cast mold, to a second sleeve holder mounted on the second wall of the cast mold. The invention also discloses that the sleeve holders can be mounted on the inner wall surface of ferrous molds using magnets. The magnets can be molded within the flange, or can be located on the outer surface of the flange.

### OBJECTS OF THE INVENTION

It is one object of the present invention to provide a novel means of attaching a mandrel unit to a mold assembly in a manner that prevents buoyancy, vibration, and other forces from dislocating the mandrel unit from its desired placement during the curing process.

It is another object of the present invention to provide a novel means for attaching a mandrel, hole former, or knock-out unit to a mold assembly, utilizing a hanging bracket that secures the hole former to a remote portion of the mold assembly, outside the area filled with casting material.

Still another object of the present invention is to provide a novel means for attaching a bracket to the mold assembly at a location remote from the cast material, utilizing a magnetic force to attach the bracket to the mold assembly.

Still another object of the present invention is to provide a method of attaching a mandrel unit to a mold assembly utilizing a magnetically attachable bracket to prevent the dislocation of the mandrel unit by buoyancy and other forces during the curing process.

### BRIEF DESCRIPTION OF THE DRAWINGS

FIG. 1 is a perspective view of the magnet assembly according to the embodiments of the current invention.

FIG. 2 is a cross sectional view of the magnet assembly as shown in FIG. 1, according to the preferred embodiments of the invention.

FIG. 3 is a cross sectional view of the magnet assembly as shown in FIG. 1, according to the preferred embodiments of the invention.

FIG. 4 is an expanded view of the plurality of magnets of the magnet assembly of FIG. 1, according to the preferred embodiments of the current invention.

FIG. 5 is a perspective view of the current invention as employed in a cast mold.

FIG. 6 is a cross-sectional view of the current invention according to the preferred embodiments of the invention.

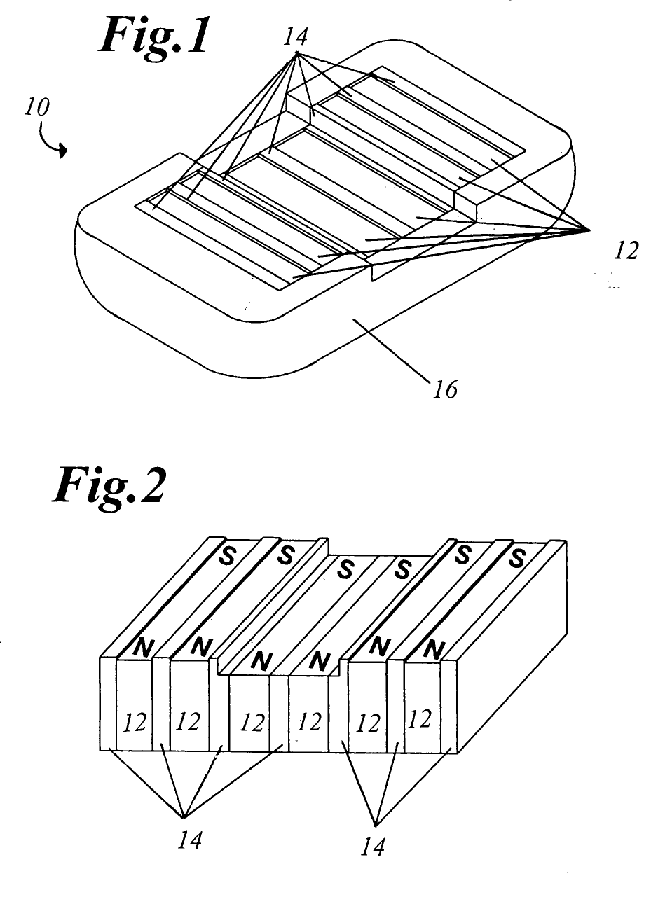

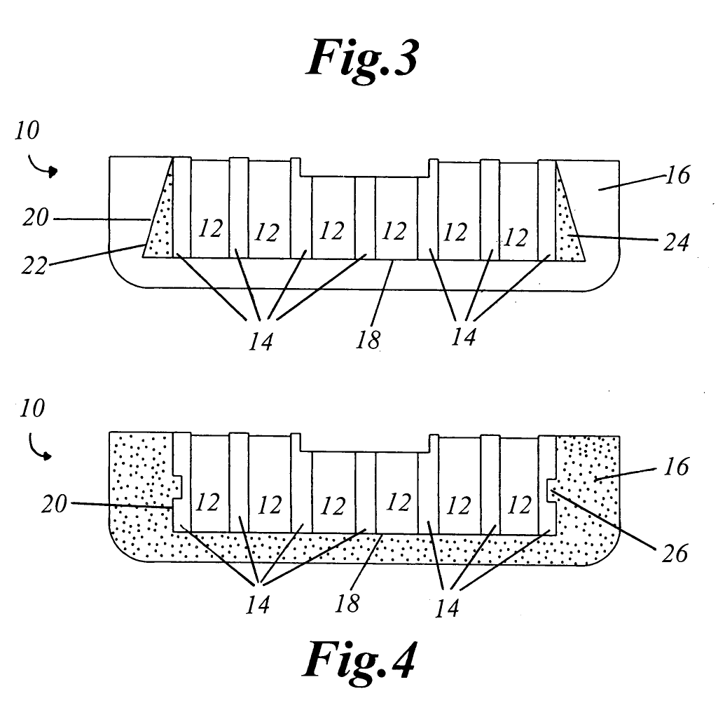

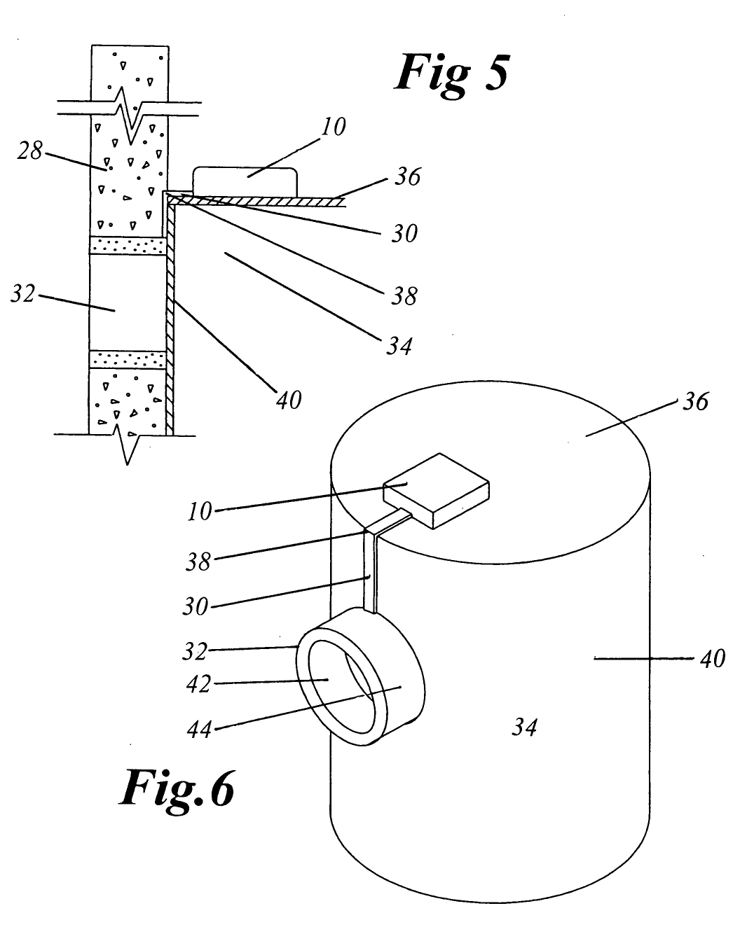

### DETAILED DESCRIPTION OF THE DRAWINGS AND THE PREFERRED EMBODIMENTS THEREIN

The device of the current invention is capable of use with a variety of hole and void forming molds, such as hole formers, mandrels, and knock-outs. However, for purposes of the description herein, these and other devices that can be used in mold casting will be collectively referred to as “hole formers.” This lexicography should not be seen as limiting the application of the invention to a sole embodiment. Rather, a “hole former” as used in this section refers to any insert to be used in mold casting that would form a hole or void in the final cast member.

Although the hole former is pictured as cylindrical, one skilled in the art would recognize that a hole former can take a variety of different shapes depending on the particular arrangement and eventual pipe attachment that is desired. However, each hole former can be described as having an outer surface and an inner surface. The hole former is capped at least at one end with an end cap, while the other end may be left open to provide access to the interior of the mandrel. The end cap is preferably contoured in shape so substantially align with the outside of the inner mold form or the inside of the outer mold jacket. If the hole is to be molded all the way through the casting, the opposite end of the mandrel should be contoured so that it substantially aligns with the form or jacket wall not matched with the end cap. In other words, the radius of curvature of the contoured ends of the mandrel should match the radius of curvature of the surface that it abuts. This prevents the mold material from entering the interior of the mandrel, thus complicating the removal of the mandrel from the hardened casting material. In the case of a drainage box however, it should be noted that the hole former end cap and opposite end will be substantially planar, since the radius of curvature for these structures is zero.

The hole former can be made of any suitable plastic, metal, wood, or other material that can be removed from the mold once the casting material has set. The hole former itself is a cylindrically shaped member that may or may not be substantially hollow.

The hole former is provided with an inner hanging support brace. The support brace extends across the diameter of the hole former, and attaches to the hole former's inner surface. The support brace can be made of any material that is capable of supporting the weight of the hole former, such as metal, alloys, wood or plastic. It should be noted that if the hole former is not substantially hollow, the support brace can constitute the whole interior portion of the hole former.

A hanging bracket is provided that is attached to the hole former. The bracket can be attached by means of a screw, a bolt, a pin insert, or any other means known in the art, so long as it is able to support the weight of the hole former. The bracket can attach to the interior or the exterior of the hole former. If the bracket is to be attached to the hole former's interior, there can be provided a hole or slot in the hole former through which the bracket can be inserted, in order to gain access to the interior of the hole former.

In a preferred embodiment, the hanging bracket fits into a slight recess in the inner mold form. This provides the inner surface of the finished mold with a more uniform and smooth structure. However, the mold form recess is not a necessary aspect of the present invention, and is only presented here as a nonlimiting feature.

The hanging bracket extends from the hole former to the edge of the inner mold form's upper surface. The bracket is there provided with a first angle. This angle first should match the angle that the surface of the inner wall forms at its intersection with the mold's upper surface. While in the present embodiment this is a 90-degree angle, this angle can vary, depending on the shape of the upper surface of the mold. While not meant to be a limitation of the present invention, the bracket works optimally when the bracket angle is set at 90 degrees. In this arrangement, the downward force exerted on the hanging bracket by gravity and the upward force exerted by the mandrel's buoyancy during casting pushes entirely against either the upper surface, or the magnet assembly. At angles other than 90 degrees, buoyancy and gravitational forces would have a vector component that might tend to displace the mandrel from its set position in the casting mold.

The bracket extends onto the upper surface of the mold, where a magnet assembly holds the bracket in its predetermined position. The magnet assembly provides a resistant force that prevents any movement of the bracket, and therefore also the mandrel, during the casting process. Preferably, the magnet assembly is provided with a recess, which is substantially the same depth as the thickness of the hanging bracket with which it interfaces. This allows the bracket to align with the bottom edge of the magnet assembly, maximizing the retaining force that the magnet exerts on the bracket.

The magnet assembly itself is preferably comprised of a plurality of magnets, although any magnetic assembly that is capable of retaining the mandrel in a stationary location can be used. The plurality of magnets should be arranged in a polar configuration that projects the strongest magnetic field away from the lengthwise surface of the magnets. This should be done in a North to North and South to South arrangement. In this way, the magnetic field generated by each of the magnets is summed together, creating a stronger magnet field that is exerted through the planar surface of the magnet assembly. This arrangement thus creates a magnetic field that is stronger than a similarly situated single magnet. The magnets can be made from any magnetic material, including but not limited to ceramic ferrite, samarium-cobalt, neodymium-iron-borom.

Disposed between the magnets are pole pieces that help to direct the flux of the magnets through the planar face of the magnet assembly. This produces a stronger magnetic attraction then could be achieved without the pole pieces. This pole piece material can be any material that is known in the art, and should not be seen as a limiting feature of the invention. However, for purposes of completeness, the preferred embodiment utilizes a carbon steel material disposed between the magnets. This material increases the additive strength of the separate magnets and directs the summed magnetic field through the planar surface of the abutted magnets. This allows a smaller magnet to oppose the gravitational and buoyant forces acting on the hole former during the casting process. The magnet assembly is therefore better able to retain the hole former and the hanging bracket in its stationary predetermined position.

As shown in FIG. 4, the individual magnets in the magnet assembly are positioned so that like polarities are adjacent one another, being separated by the pole pieces. In order to overcome the repulsive forces that the like poles have on each other, the individual magnets must be bonded to the adjacent pole pieces. This can be accomplished by any means known in the art, however for purposes of completeness, the magnets of the present embodiment are bonded to the pole pieces with an epoxy. In another embodiment, the magnets and the pole pieces can be held together by the metal casing, either by compressive force, or by the use of a cast in ridge, described infra.

The magnet casing can be made from any material that is capable of retaining the disposed magnets, including metals, alloys, and plastics. The current embodiment utilizes a high-grade aluminum that can either be machined or molded into the desired casing shape. The magnet casing has an interior that is capable of receiving the disposed magnets. When the magnet casing is machined, the inner wall of the magnet casing can be provided an inverse chamfer. When the disposed magnets are inserted into the machined casing, an epoxy can be utilized in order to retain the magnets within the casing interior. When an inverse chamfer is provided, the epoxy will fill the chamfered area that is not filled by the magnets. This creates a situation where the magnet/epoxy piece is larger at one end of the chamfered casing than is the opening into the interior of the casing. Thus, it is very difficult to remove the magnets from the casing without fracturing the epoxy/magnet bonding.

When the casing is cast molded around the disposed magnets, a magnet groove can be employed along the disposed magnets to aide in the retention of magnets within the casing. This groove is located around the perimeter of the disposed magnets, such that the cast material fills the groove during the casting process. Thus, once cast, the disposed magnets are virtually locked into place with in the interior of the casing. This prevents the unwanted removal of the magnets from the casing. While the temperatures that are necessarily employed in the casting of the casing have a detrimental effect on the magnetic strength of the disposed magnets, one of ordinary skill in the art would recognize this and make the necessary adjustments in the magnet size or composition to overcome this.

During the casting process, it is not uncommon for the casing to become embedded in the casting material. While it is with it is with in-the scope of the invention to use the coat the magnet assembly with a releasing agent, an optional feature of the magnet assembly is provided to further ease recovery of the magnet assembly. To overcome adhesion to the cast material, the casing of the current invention can optionally include a disposable blister pack. This blister pack is an expendable covering that attaches itself to the exterior of the casing, thus preventing the casing surface from coming into contact with, and adhering to the cast material.

The blister pack can be made from any suitable material, however plastic is preferred. The interior of the plaster pack is contoured so that it substantially matches the shape of the outer surface of the magnet casing. This minimizes the amount of material need for the blister pack, and also prevents seepage of casting material between the blister pack and the casing, which could make removal more difficult. The blister pack can be attached to the exterior of the casing using any means known in the art including tape, glue, brackets and the like. Preferably, the blister pack “snaps” onto the casing, and is retained by the blister pack clasping around the body of the casing.

When the hole former assembly is properly aligned within the mold assembly, an outer jacket is positioned concentrically around the inner mold. While the current embodiment describes this as a cylindrical shape, one skilled in the art would recognize that other shapes could be used, depending on the final application for the cast member. The outer jacket, similar to the inner mold form, can be composed of any acceptable material that is resistant to the casting material. Therefore, in the case of concrete casting, the outer jacket could be made of wood, fiberglass, metal, metal alloys, plastic, or any other material that one of ordinary skill in the art would recognize as suitable.

The outer jacket is aligned with the inner mold form and the hole former assembly so that the inner wall of the outer jacket is adjacent and flush with the hollow edge of the mandrel assembly. This abutted arrangement of the mandrel to the outer jacket is necessary to ensure that the cast hole penetrates the entirety of the cast member. The abutted arrangement also prevents the casting material from flowing into the interior of the hole former assembly, which would make removal of the hole former from the cast member more difficult. When a knock-out assembly is used, the hole former will only abut one of the inner wall or the outer jacket. This is utilized to make a thinner section of cast material.

The space between the outer jacket and the inner mold form is filled with casting material. When the casting material hardens, the cast is removed from the mold form. The magnet assembly, which is embedded in the cast material, can then be removed. To facilitate removal of the magnet assembly, a metal handle or other magnetically attractable member can be adhered to the magnet assembly. The magnetic attraction by the magnet assembly to the metal handle is greater than the adhesive forces between the cast member and the magnet casing. One can then simply lift the magnet assembly out of the cast material.

When a blister pack is utilized, removal of the magnet assembly becomes even easier. A handle is magnetically adhered to the magnet as above. However, it is not necessary to fracture the casing/casting adhesion. The magnet assembly simply “unsnaps” from the blister pack, leaving the disposable blister pack embedded in the final cast member.

### SUMMARY OF THE ACHIEVEMENT OF THE OBJECTS OF THE INVENTION

From the foregoing, it is readily apparent that we have invented a novel apparatus and method for positioning and securing a hole former during a cast molding process. The current invention utilizes a magnetic anchoring assembly placed atop the inner mold form, that holds a bracket. The bracket is aligned horizontally with the outer wall of the inner mold, and attaches to a mandrel. The mandrel defines the hole in the final cast material, which the magnet prevents movement of the mandrel during casting. Additionally, by using brackets of differing lengths or adjusting the bracket/mandrel attachment, the hole former of the current invention can be reused to create holes in differing locations for different cast members without damaging the structure of the mold as does many of the prior art devices. Finally a blister pack can be utilized with the magnetic assembly to facilitate the removal of the magnetic assembly from the cast member.

It is to be understood that the foregoing description and specific embodiments are merely illustrative of the best mode of the invention and the principles thereof, and that various modifications and additions may be made to the apparatus by those skilled in the art, without departing from the spirit and scope of this invention, which is therefore understood to be limited only by the scope of the appended claims.

1. A device for positioning a hole former within a casting mold, said casting mold comprising an inner mold form and an outer jacket, said inner mold form further comprising an inner surface and an upper surface, said device comprising:
At least one hole former member that is adapted for secured placement against at least one of said inner surface or outer jacket;
At least one bracket member capable of attachment to said mandrel member, said bracket member adapted to substantially abut said inner surface and said upper surface;
At least one magnet assembly, said magnet assembly being adapted to releasably attach said bracket to said upper surface.

2. The device for positioning a hole former of claim 1, wherein said at least one magnet assembly comprises a plurality of magnets, a plurality of pole pieces, and an outer casing.

3. The device for positioning a hole former of claim 2, wherein said outer casing further comprises a cavity, wherein said plurality of magnets are alternatingly disposed with said plurality of pole pieces.

4. The device for positioning a hole former of claim 3, wherein said alternatingly disposed plurality of pole pieces and said alternatingly disposed plurality of magnets further comprises a channel that is capable of receiving said bracket member.

5. The device for positioning a hole former of claim 4, wherein said plurality of magnets are constructed of a material selected from a group consisting of ceramic ferrite, samarium-cobalt, neodymium-iron-borom, or a combination thereof.

6. The device for positioning a hole former of claim 4, wherein said pole pieces are constructed of carbon steel.

7. The device for positioning a hole former according to claim 3, wherein said magnet assembly further comprises an epoxy for retaining said alternatingly disposed magnets and pole pieces within said cavity.

8. The device for positioning a hole former according to claim 7, wherein said cavity further comprises a chamfered inner wall creating a space between said inner wall and said alternatingly disposed magnets and alternatingly disposed pole pieces, said space being substantially filled by said epoxy.

9. The device for positioning a hole former according to claim 3, wherein said magnet assembly further comprises a magnet groove that is capable of interfacing with said outer casing.

10. A magnet assembly comprising a plurality of magnets, a plurality of pole pieces, and an outer casing, said outer casing further comprises a cavity, wherein said plurality of magnets are alternatingly disposed with said plurality of pole pieces.

11. A method of positioning a hole former to be used in cast material with in a casting mold comprising an inner mold form and an outer jacket, said inner mold form further comprising an inner surface and an upper surface, said method comprising the steps of:
anchoring a bracket having a first end and a second end to said upper surface of said casting mold at said first end of said bracket using a magnet assembly;
attaching a hole former assembly to said second end of said bracket, said second end being remotely located from said first end; and
securely positioning said hole former against at least one of said inner surface and said outer jacket.

12. The method for positioning a hole former of claim 11, wherein said at least one magnet assembly comprises a plurality of magnets, a plurality of pole pieces, and an outer casing.

13. The method for positioning a hole former of claim 12, wherein said outer casing further comprises a cavity, wherein said plurality of magnets are alternatingly disposed with said plurality of pole pieces.

14. The method for positioning a hole former of claim 13, wherein said alternatingly disposed plurality of pole pieces and said alternatingly disposed plurality of magnets further comprises a channel that is capable of receiving said bracket member.

15. The method for positioning a hole former of claim 4, wherein said plurality of magnets are constructed of a material selected from a group consisting of ceramic ferrite, samarium-cobalt, neodymium-iron-borom, or a combination thereof.

16. The method for positioning a hole former of claim 14, wherein said pole pieces are constructed of carbon steel.

17. The method for positioning a hole former according to claim 13, wherein said magnet assembly further comprises an epoxy for retaining said alternatingly disposed magnets and pole pieces within said cavity.

18. The method for positioning a hole former according to claim 17, wherein said cavity further comprises a chamfered inner wall creating a space between said inner wall and said alternatingly disposed magnets and alternatingly disposed pole pieces, said space being substantially filled by said epoxy.

19. The method for positioning a hole former according to claim 13, wherein said magnet assembly further comprises a magnet groove that is capable of interfacing with said outer casing.

20. A cast object with a hole formed therein made according to the method of claim 11.
